(19) United States
(12) Patent Application Publication
(10) Pub. No.: US 2003/0101102 A1
(43) Pub. Date: May 29, 2003

(54) Prepayment and profit distribution system for unrealized goods on internet

(76) Inventor: Gyu Ho Kim, Seoul (KR)

Correspondence Address: Law Office of Royal W Craig, Suite 153, 10 North Calvert Street, Baltimore, MD, 21202, US

(21) Appl. No.: 10/204,927

(22) PCT Filed: Feb. 23, 2001
(86) PCT No.: PCT/KR01/00278

(30) Foreign Application Priority Data
Feb. 24, 2000 (KR) 2000-9037

(51) Int. Cl. G06F 17/60

(52) U.S. Cl. 705/26

(57) ABSTRACT

Provided is a prepayment and profit distribution system on the Internet, which allows customers to buy goods and/or services or both that are being produced or planed to produce, and which provides customers with the goods when finished, and distributes profit based on sales of goods. The system includes a database for storing information on goods currently being produced or under plan for production, a database for storing receipt details regarding the request for purchase of goods, a home page for providing a customer who has connected thereto through the Internet with goods information, making settlement of the price of the goods with a pertinent financial institution's server if the customer applies for prepayment for particular goods, receiving the prepayment request and recording the receipt details if settlement is successfully made, and a web server for performing a function for completing a prepayment service for the corresponding goods.

### TECHNICAL FIELD

The present invention relates to a prepayment and profit distribution system for unrealized goods on the Internet, and more particularly, to a service system which allows customers to buy goods and/or services or both that are being produced or planed to produce, for example, unpublished books, unreleased records or entertainment performances, provides customers with the goods when finished, and distributes profit based on sales of goods.

### BACKGROUND ART

In recent years, according to simplicity of WWW (World Wide Web) based on HTML (Hypertext Markup Language) and development of multimedia technology, Internet users have explosively increased in number. Accordingly, numerous applications have been developed to provide various kinds of services on the cyber space. In particular, with the advent of various kinds of cyber shopping malls over the Internet, electronic transaction technology has become items of customer's primary interest. Also, various kinds of search and mailing services are being offered over the Internet.

Things that are sold on existing Internet shopping malls are finished goods, records or tickets for entertainment performances. Thus, customers purchase their desired goods, and receive the purchased goods in a predetermined transit time or go to see a drama or movie on a specified date.

If even unrealized goods are possibly sold in advance, the producers of the corresponding goods will have the advantage of funding and can advantageously predict customers' preference. From the viewpoint of customers, the disadvantage of prepayment for unrealized goods can be overcome by distribution of some of profit based on sale. In particular, customers can support creative works of their favorite authors, singers, producers or performers, by purchasing their books, records or movie/drama tickets in advance.

### DISCLOSURE OF THE INVENTION

To solve the above problems, it is an objective of the present invention to provide a prepayment and profit distribution system which are of benefit to both producers and customers such that goods currently being produced or under plan for production are prepaid through electronic transaction on the Internet, allowing producers to understand the goods' popularity and to raise funds for production of good quality goods, and the goods is provided to pre-payers and profits based on sales of the goods are distributed to the pre-payers, if the production of the goods is finished.

To accomplish the above object of the present invention, there is provided a prepayment and profit distribution system using the Internet, for providing pre-payers with goods and distributing some of profits based on sales of goods to the pre-payers, comprising: a first goods information database (DB) for storing information on goods currently being produced or under plan for production; a home page for providing a customer who has connected thereto through the Internet with goods information stored in the first goods information DB, and processing prepayment requests for particular goods if settlement of the price of the goods with a pertinent financial institution's server is successfully made; a first receipt details DB for storing receipt details for the prepayment requests processed on the homepage; and a web server for performing an “occasional notice function” of recording the information on the development of production of the goods on the home page and transferring the information on the development to e-mail addresses of the pre-payers, in connection with the first goods information DB and the first receipt details DB, a “goods use information transfer function” of transferring the information that enables the pre-payers to use the goods to the pre-payers by e-mail, if the production of the goods is finished, in connection with the first receipt details DB, a “transportation information output function” of outputting information to be indicated on the corresponding goods or packing to transport the goods to the pre-payers, in connection with the first receipt details DB, and a “profit transfer function” of transferring the profit based on sales of the goods from a designated bank account to each pre-payer's bank account, in connection with the first receipt details DB. The first goods information DB, the home page, the first receipt details DB and the web server are linked with each other on the Internet to be connected with customers on the Internet.

The “profit transfer function” further includes a function of transferring the amount of distribution of the profit based on sales of the goods to the customers after the production of the goods is finished to a server of each pre-payer's designated network operator and deducting the amount of distribution from charges for each pre-payer's communication services.

Furthermore, integrated implementation is preferred, such that each producer's goods information is registered in an Internet site constructed by a third operator to then be provided with the goods and profits based on sales of the goods in an integrated manner.

To this end, a third operator's home page performs a function of collecting information on goods currently being produced or planned to produce from a producer on-line on the Internet, storing the collected goods information in a first goods information DB, and providing a customer who has connected thereto through the Internet with goods information stored in the first goods information DB, and a function of recording receipt details of the pre-payers made with a pertinent financial institution's server on a first receipt details DB. A third operator's web server performs a function of transferring the receipt details of the pre-payers recorded on the first receipt details DB to the producer's computer having uploaded the goods information, and a function of transferring the price of the goods received from the pre-payers with the commission of the third operator deducted to the producer's designated bank account. The producer's computer performs a function of transferring the goods information to a third operator's web site in connection with a second goods information DB in which the goods information currently being produced or planned to produce from the producer is stored, a function of recording the receipt details of the pre-payers transferred from the third operator's web site on a second receipt details DB, and a function of transferring information on the development of production of the goods to the third operator's web site. The third operator's web site, the producer's computer and the customers are connected to each other on the Internet.

The producer's computer performs an occasional notice function, a goods use information transfer function, a transportation information output function and a profit transfer function, in connection with the third operator's web site, the second goods information DB and the second receipt details DB on the Internet.

### BRIEF DESCRIPTION OF THE DRAWINGS

FIG. 1 is a schematic diagram showing the flow of prepayment according to the first embodiment of the present invention;

FIG. 2 is a block diagram of a prepayment and profit distribution system according to the first embodiment of the present invention;

FIG. 3 shows the construction of databases shown in FIG. 2;

FIG. 4 is a flowchart showing an exemplary implementation of a home page;

FIG. 5 shows an example of a home page screen;

FIG. 6 is a flowchart of a settlement procedure according to the first embodiment of the present invention;

FIG. 7 is a flowchart showing an exemplary function of a web server according to the present invention;

FIG. 8 is a schematic diagram showing the flow of prepayment according to the second embodiment of the present invention;

FIG. 9 is a block diagram of a prepayment and profit distribution system according to the second embodiment of the present invention;

FIG. 10 is a flowchart of an exemplary upload procedure according to the present invention; and

FIG. 11 is a flowchart showing an exemplary function of the system according to the second embodiment of the present invention.

### BEST MODE FOR CARRYING OUT THE INVENTION

Hereinafter, preferred embodiments of the present invention will be described in detail with reference to the attached drawings.

For a better understanding of the present invention, terms used throughout the description set forth herein will first be defined.

The term “customer” as used herein means one who intends to buy goods.

The term “producer” as used herein means one who produces particular goods or plans to produce the same. In the case where a seller and a producer are different, the seller may also be considered as the producer at the time when the goods are finished.

The term “pre-payer” as used herein means one who purchases desired goods in advance.

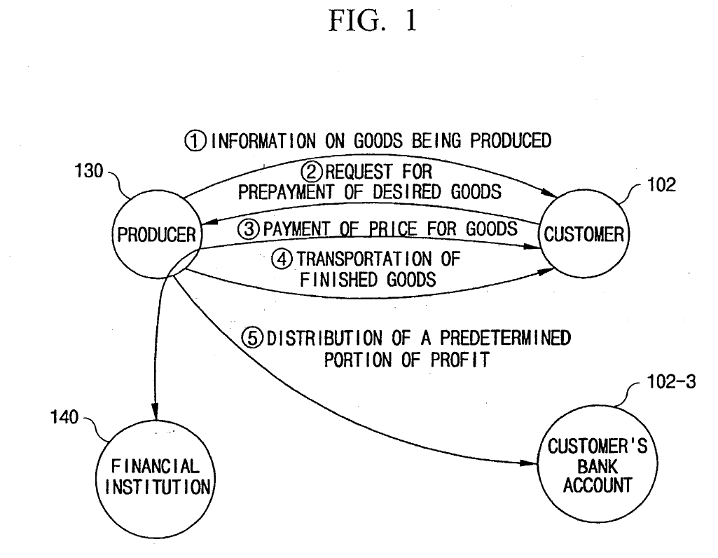

FIG. 1 is a schematic diagram showing prepayment according to the first embodiment of the present invention. Referring to FIG. 1, a prepayment service rendered by a producer will be described by way of example.

A producer 130 provides a customer 102 with information on goods that are currently being produced or are planned to produce. The customer 102 applies for prepayment for desired goods to the producer 130, by referring to the goods information provided by the producer 130, and the customer 102 pays for the goods to a pertinent financial institution 140 by a customer's designated method. When the goods prepaid by the customer 102 is finished at a later time, the producer 130 delivers the finished goods to the customer 102. Also, the producer 130 transfers some of profit based on sales of the goods to customer's bank account 102-3, for profit distribution.

In more detail, the producer 130, either a company or an individual, operates an Internet site for providing a prepayment service on the Internet. The customer 102 connects to the producer's Internet site on-line. Off-line connection is also possible.

The Internet site introduces products that will be finished by the producer 130. Examples of the producer 130 are drama producers, authors, record planners, and so on, by whom dramas or plays, books, musical records and the like, are produced as finished products. In reality, the producer 130 may be one or more individuals who serve different parts.

The customer 102 connects to the Internet site to investigate information on the goods to be finished by the producer 130, and then purchases desired goods in advance to become a pre-payer. The goods can be classified according to type, author, singer, actor (actress), theme and so on. When the goods are finished by the producer 130, the corresponding goods are delivered to the pre-payer. The producer's autograph or message may be written on the goods to be delivered to the customer 102, by which the customer (pre-payer) 102 may feel a sense of closeness toward the producer 130. Also, the producer 130 pays some of profit acquired back to the pre-payer by cash or goods.

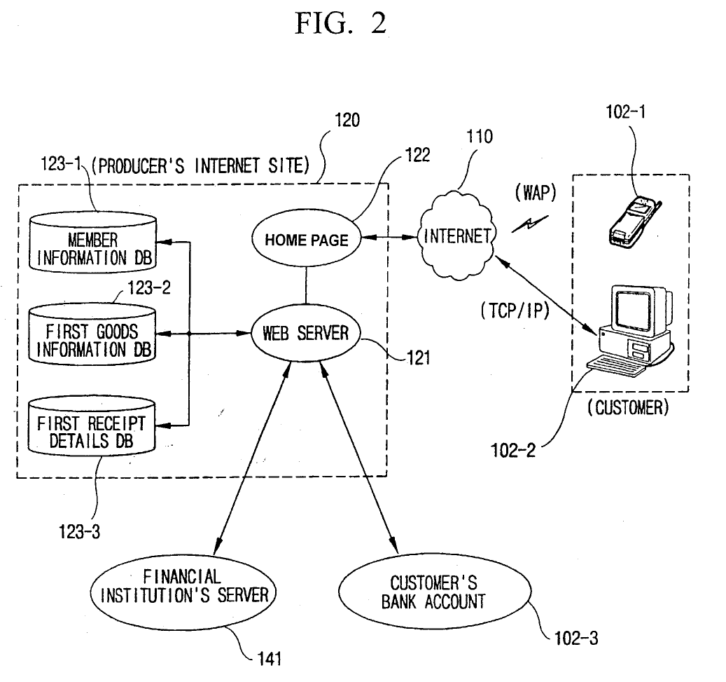

FIG. 2 is a block diagram of a prepayment and profit distribution system according to the first embodiment of the present invention, chiefly showing an Internet site.

The Internet site is a combination of software configuration such as home page, web server or database, and hardware configuration. The home page is run by the web server, and operating in a close connection with the web server. Thus, the home page and the web server are quite difficult to distinguish. Hereinafter, the software to which the customer substantially access will be referred to as home page, and the hardware will be referred to as web server. The web server and the home page are collectively referred to as Internet site. The functions performed by these two factors can be generally said to be performed by the Internet site, without making any difference in meaning.

Referring to FIG. 2, an Internet site 120 is composed of a member information database (DB) 123-1, a first goods information DB 123-2, a first receipt details DB 123-3, a web server 121 and a home page 122.

Here, the member information DB 123-1 is a component for storing customers' personal information for customers subscribed as members, that is, general information including name, address, ID, password and so on. The function and structure of the member information DB 123-1 are widely known and a detailed explanation thereof will not be given. The system of the present invention will not be necessarily given only to members.

The first goods information DB 123-2 is a component for storing information on goods currently being produced or under plan for production. The first receipt details DB 123-3 is a component for storing receipt details regarding the request for purchase of goods. In other words, the first goods information DB 123-2 and the first receipt details DB 123-3 are initially and constantly updated.

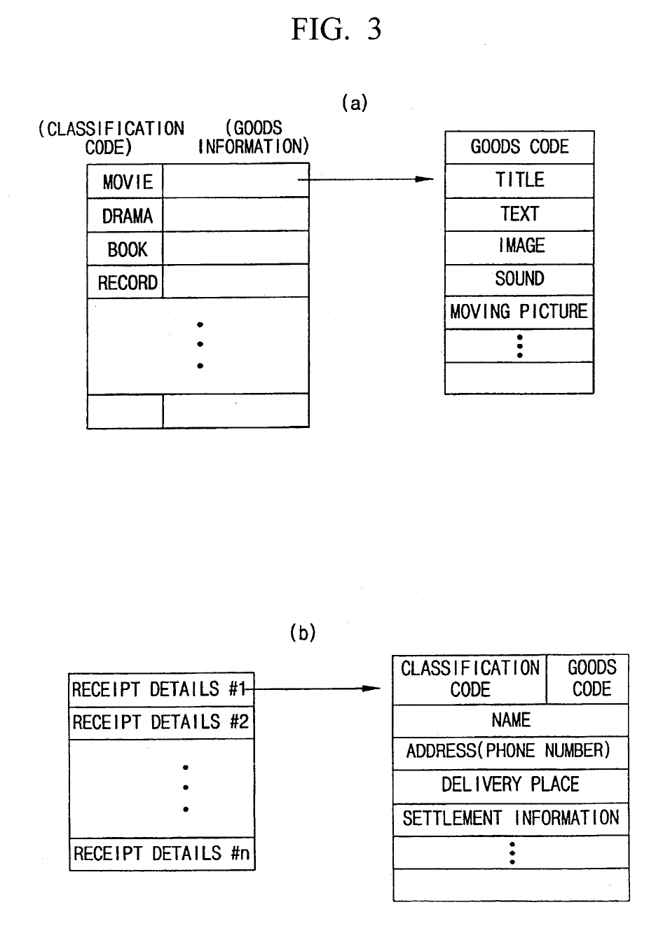

FIG. 3 shows the construction of databases shown in FIG. 2, in which (a) of FIG. 3 shows the structure of the first goods information DB 123-2, consisting of a field of classification codes and a field of goods information. The classification codes correspond to kinds of goods, including movie, drama, book, record and so on. The goods information includes titles, texts, images, sound or moving pictures appropriately describing the goods, according to the classification codes and features of the goods. (b) of FIG. 3 shows the structure of the first receipt details DB 123-3, consisting of fields of receipt details. The respective fields may be classification code, goods code, pre-payer's name, address, phone number, mailing address or payment information.

The structures of the DBs shown in (a) and (b) of FIG. 3 are provided only for better understanding of the invention in a non-limiting manner.

The Internet site 120 is connected to each customer's wireless terminal 102-1 or personal computer (PC) terminal 102-2 through the Internet 110. The term “Internet” used herein represents both a wired Internet and a wireless Internet.

In other words, when the customer connects to the Internet 120 using the PC terminal 102-2, connection to the Internet site 120 is made by the wired Internet based on a TCP/IP (Transmission Control Protocol/Internet Protocol) method. When the customer connects to the Internet 120 using the wireless terminal 102-1 such as PDA or cellular phone, connection to the Internet site 120 is made by the wireless Internet based on a WAP (Wireless Application Protocol) method. Thus, the home page 122 must also be customized according to each method. The technology of constructing wired and wireless Internet sites is well known in the art, and a detailed explanation thereof will not be given.

If a customer connects to the home page 122 through the Internet 110 using the terminal 102-1 or 102-2, the home page 122 provides goods information stored in the first goods information DB 123-2 in a predetermined format. If the customer applies for prepayment for particular goods, settlement for the goods is made with a pertinent financial institution's server. If settlement is successfully made, the prepayment request is received and the receipt details are recorded in the first receipt details DB 123-3.

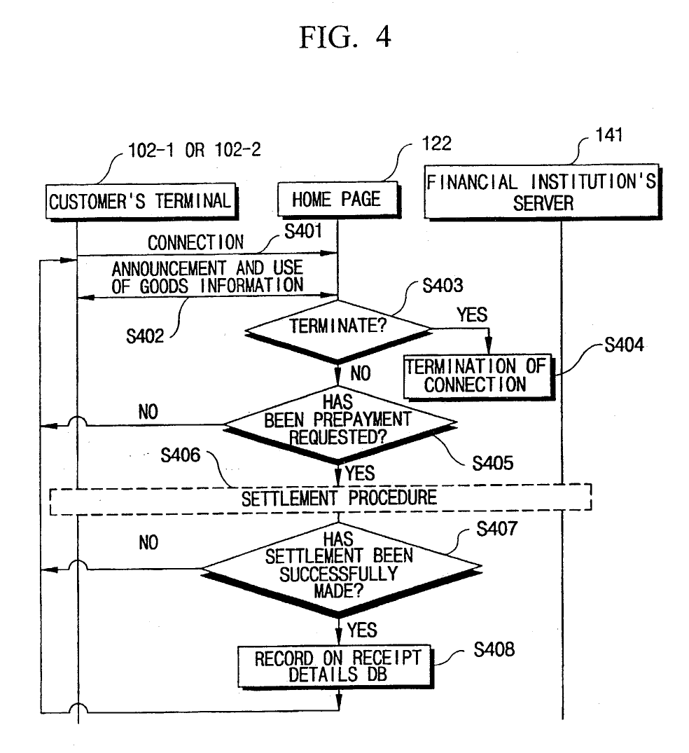

This procedure will now be described in detail with reference to FIG. 4.

The customer connects to the home page 122 using the customer's terminal 102-1 or 102-2 (step S401) to use various kinds of goods information offered by the home page 122 (step S402).

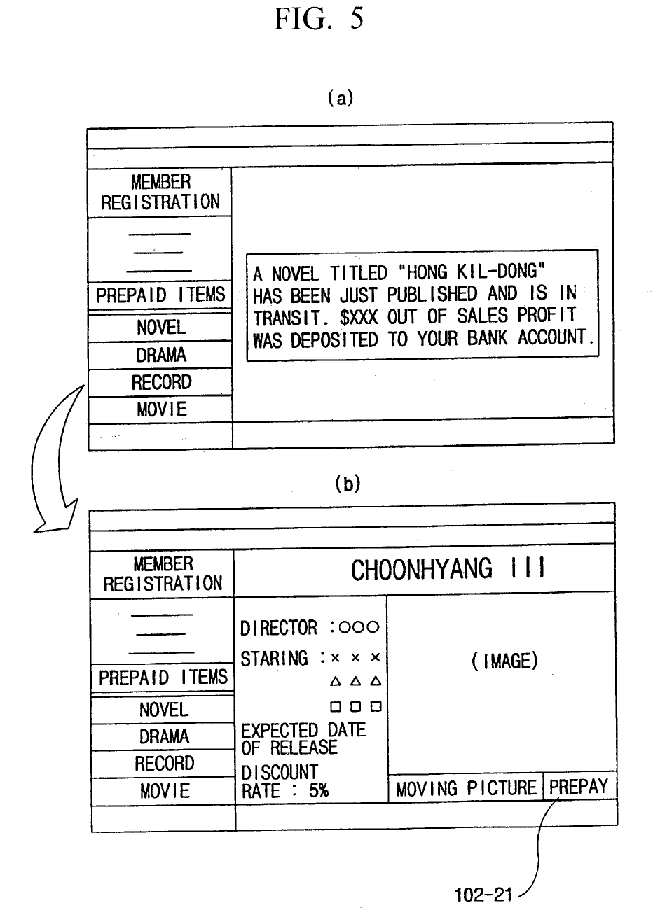

After just using the information offered by the home page 122, the customer may terminate the connection with the home page 122 (steps S403 and S404). If the customer intends to buy particular goods through prepayment, the customer may select a corresponding item. Referring to FIG. 5(B), request for prepayment is notified to the home page 122 by clicking on a “PREPAY” button 102-21.

If the customer requests prepayment for particular goods (step S405), the home page 122 makes settlement of the price for the corresponding goods by the customer's designated payment method (step S406). Here, the customer's request for prepayment may be once received, and then settlement may be done when the goods are actually provided to the customer. However, in order to financially assist the producer in producing the goods, settlement is preferably made at the time when the customer requests for prepayment.

If the settlement step (S406) is successfully performed (step S407), the prepayment details are recorded on the first receipt details DB 123-3, and then the procedure goes back to step S402 to continue to provide a goods information service (step S408).

FIG. 5 shows an example of a home page screen, showing the case where the user's terminal is a personal computer 102-2. As shown in (a) of FIG. 5, the screen of the home page 122 may be composed of several parts; member registration, product category for customer's prepayment, information on available services, various banners, and its configuration can be arbitrarily varied.

If a customer clicks on a movie item to examine movies that are currently being produced, a screen shown in (b) of FIG. 5 appears. If a movie titled “Choonhyang III” is currently being produced, moving pictures concerning introduction of the director(s), actor(s) and/or actress(es) who participate in production of the movie, expected date of release, discount rate on prepayment, advertisement image, filming episode or some preview scenes, can be offered.

Also, in order to implement the present invention, a user must display a prepayment enabling means for the corresponding product, e.g., an admission ticket for Choonhyang III, as indicated by the “PREPAY” button 102-21 as shown in (b) of FIG. 5.

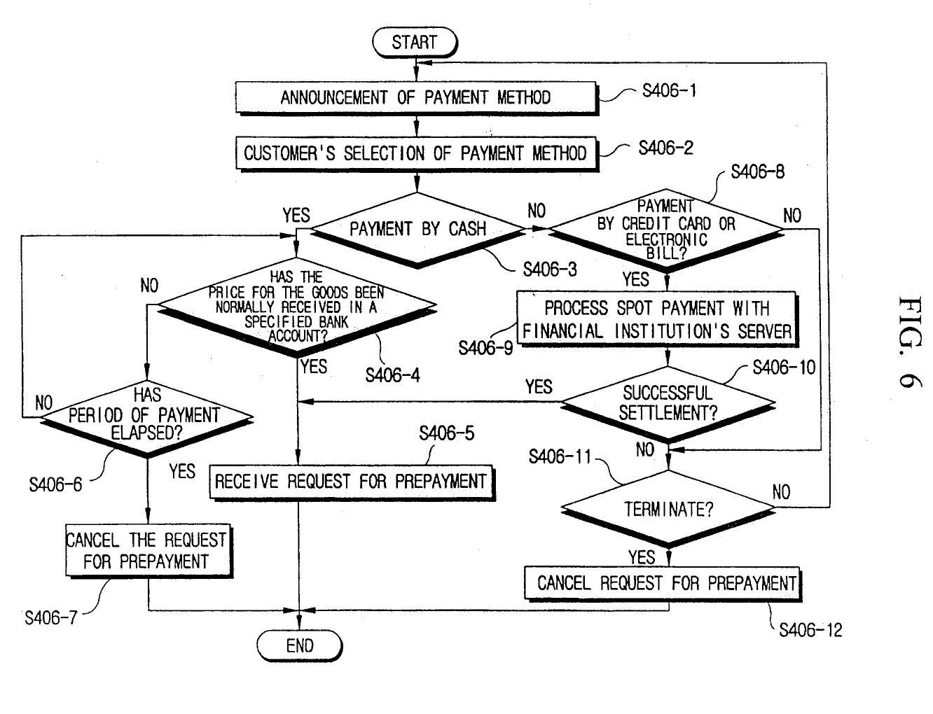

FIG. 6 is a flowchart of a settlement procedure according to the first embodiment of the present invention. Referring to FIG. 6, a settlement procedure for the above-described product will be described in detail by way of example.

First, the home page 122 announces details necessary for each payment method to the customer's terminal 102-1 or 102-2 (step S406-1). Then, the customer selects a desired payment method based on the announcement (step S406-2).

In step S406-2, if the customer selects a cash payment method, the home page 122 checks whether the price for the goods has been normally received in a specified bank account within a prescribed period of payment (steps S406-4 and S406-6). If the price for the goods has been normally received, the request for prepayment is received (step S406-5), and if not, the request for prepayment is canceled (step 406-7).

However, if the payment method selected by the customer in step S406-2 is a spot payment method, such as payment by credit card or electronic bill (step S406-8), settlement for the goods is made between the customer's terminal 102-1 or 102-2 and the pertinent financial institution's server 141 (step S406-9). For example, in the case of the credit card based payment, the customer's terminal 102-1 or 102-2 is connected to a credit card company server or its agency server so that details necessary for payment are input to request payment. In another example, settlement of the price for the corresponding goods can be made with the financial institution's computer such that the information on the price for the corresponding goods is sent to the server of a customer's designated network operator (e.g., Korea Telecommunication) so that the server bills the customer for the price for the goods together with charge to a network service account.

The home page 122 checks in step S406-10 whether the price for the goods is normally paid or not, and if yes, receives the request for prepayment (step S406-5), or if not, the procedure goes back to step S406-1 according to customer's selection in step S406-11 to allow the customer to select a payment method again or to terminate the procedure for cancellation of the request for prepayment (step S406-12).

When the production of the customer's selected goods is finished at a point of future timing, the producer delivers the goods to the customer and distributes some of profit based on the sales of the goods to customers who prepaid the corresponding goods. To this end, if information on whether production of a certain goods has been finished or not, the information stored in the first goods information DB 123-2, is received, the web server 121 performs a function for completing a prepayment service for the corresponding goods.

In an embodiment of the function for completing the prepayment service, the fact that production of the corresponding goods has been finished is recorded on the home page 122, and the receipt details for the finished goods are searched from the first receipt details DB 123-3 to be output to a screen or output device according to a prescribed format, so that the producer can be informed of the details.

An irregular period of time will be required until producer's goods prepaid by customers are actually finished and delivered to the customer. Thus, it is desirable to inform customers of information on the development of production of the goods as occasion demands. Also, even when the production of goods is finished, it will take some time to deliver the goods actually. Thus, it is necessary to inform customers of the estimated time for actual delivery of the goods.

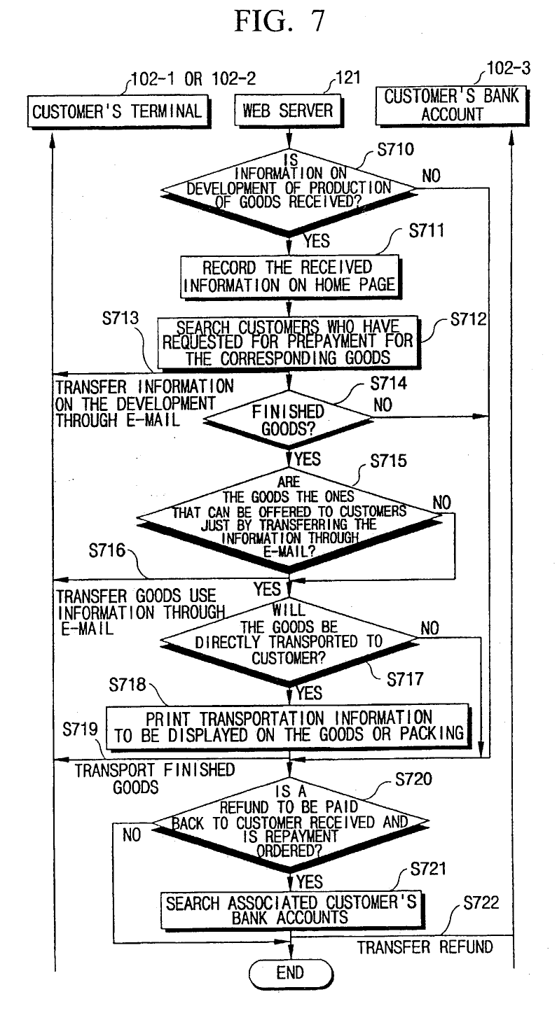

Referring to FIG. 7 showing an exemplary function of a web server according to the present invention, if the information on the development of production of the goods stored in the first goods information DB 123-2 is received (step S710), the web server 121 records the received information on the home page 122 so as to inform customers (step S711).

In order to effect customer-oriented services, customers who have requested for prepayment for the corresponding goods are searched from the first receipt details DB 123-3 (step S712), and then the information on the development is transferred to e-mail addresses of the searched customers (step S713). For brevity of explanation, functions defined in steps S710 through S713 will be referred to as an “occasional notice function”. Recordation on the home page 122 and notice through e-mail can be simultaneously performed, or can be optionally performed.

If the received development information is the one indicating that production has been finished (step S714), the web server 121 performs a goods transportation procedure.

Here, if the finished goods are the ones that can be offered to customers just by transferring the information through e-mail (step S715), the information that enables customers to use the goods is transferred to the customers by e-mail (step S716). Examples of such goods include movie or drama tickets. In this case, a specific number is given to each customer by e-mail, and the customer can be admitted to a movie or drama theater by presenting the specific number to a ticket examiner. For brevity of explanation, functions defined in steps S714 through S716 will be referred to as a “goods use information transfer function”.

The web server 121 determines whether the goods must be directly transported to the customer (step S717), and, if yes, outputs information to be indicated on the corresponding goods or packing (step S718). Transportation information means information necessary for transporting the goods by post or quick delivery, including customer's address, postal code or column for customer's confirmation. For brevity of explanation, functions defined in steps S717 and S718 will be referred to as a “transportation information output function”.

The finished goods are transported to the customer with the transportation information indicated thereon (step S719).

One of important features of the present invention is to pay a predetermined portion of the profit from sales of the corresponding goods back to the customer, in recompense for prepayment.

In other words, if a refund to be paid back to the customer is received and repayment is ordered (step S720), the web server 121 searches customers who have prepaid for the corresponding goods (step S721). Then, the refund is transferred from a designated bank account to the customer's bank account (step S722). For brevity of explanation, functions defined in steps S720 through S722 will be referred to a “profit transfer function”.

The “profit transfer function” preferably includes a function of transferring a refund to the server of each customer's designated network operator. In other words, the amount of refund may be deducted from charges for communication services, e.g., telephone, leased line or pager. Here, the network operator's commission may be deducted from the refund. In such a manner, profit-repaying methods can be varied.

The system according to the first embodiment of the present invention is for the case where the operator of the Internet site 120 is the very producer 130. However, in order to embody the invention in more effectively, integrated implementation, rather than independent implementation by each producer, is preferred, such that each producer's products are registered in an Internet site constructed by a third operator to then be provided with prepayment services in an integrated manner.

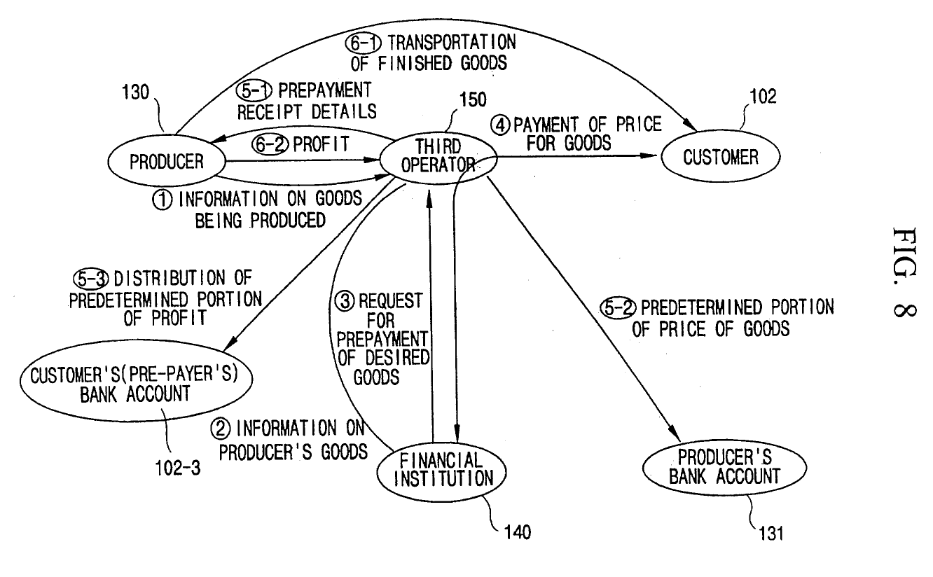

FIG. 8 is a schematic diagram showing the flow of prepayment according to the second embodiment of the present invention. A third operator 150 collects from the producer 130 information on goods currently being produced or planned to produce, and offers the collected information to the customer 102. Here, the producer 130 may transfer the goods information to the third operator 150 on-line, by mail or by direct mailing.

Then, the customer 102 having received the goods information offered by the third operator 150, requests the third operator 150 to prepay any desired goods, and then settlement is made with a pertinent financial institution 140 by a customer's designated payment method.

If settlement is made, the third operator 150 notifies the producer 130 of receipt details, so that the producer manages customers who prepaid for producer's goods. Also, the third operator 150 transfers the price for the goods received from the customer 102 to the pertinent producer 130, with the commission of the third operator 150 deducted. If the prepaid goods are finished at a future timing, the producer 130 transports the corresponding goods to the customer. If profit based on sales of goods arises, the profit is transferred to the third operator 150, and the third operator 150 pays a predetermined portion of the profit, excluding commission, back to the customer 102.

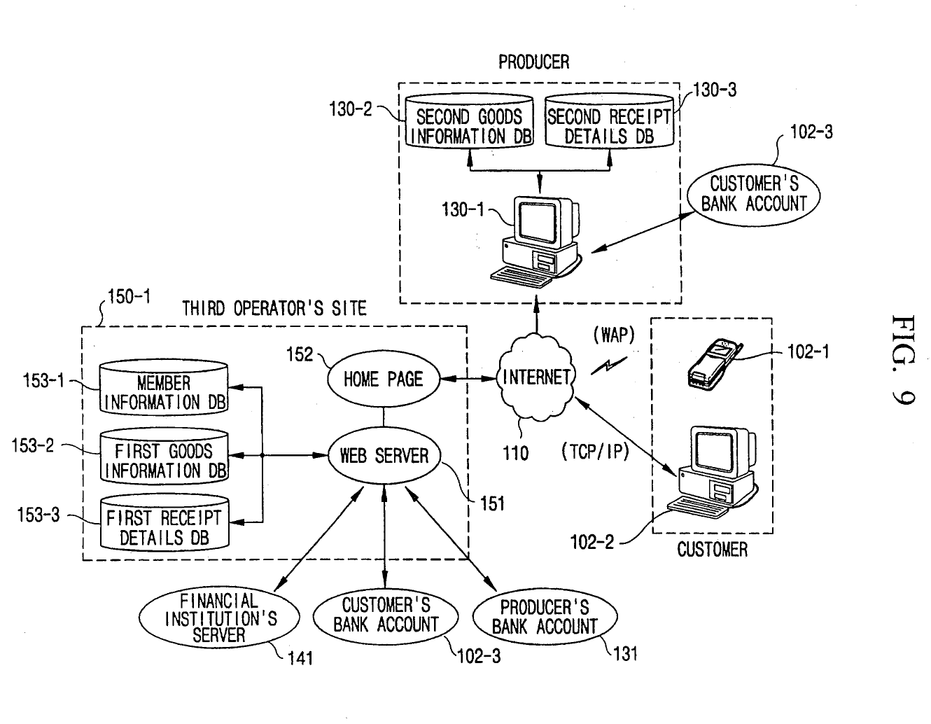

FIG. 9 is a block diagram of a prepayment and profit distribution system according to the second embodiment of the present invention, where an Internet site 150-1 is operated by the third operator 150, and the producer's computer 130-1 is connected to the Internet site 150-1 via an arbitrary network, e.g., the Internet 110. Here, it is preferred that the producer manages customers who purchased producer's goods. To this end, the producer's computer 130-1 is preferably constructed to be linked with a second goods information DB 130-2 in which information on goods currently being produced or planned to produce, is stored, and a second receipt details DB 130-3 in which the receipt details sent from a home page 152 are recorded.

In the above-described system, the producer 130 may transfer the goods information to the third operator 150 in various ways, e.g., by mail or by direct mailing. However, a transferring method by connection to the home page 152 through the Internet 110, is preferred. Of course, necessary goods information can by transferred through e-mail.

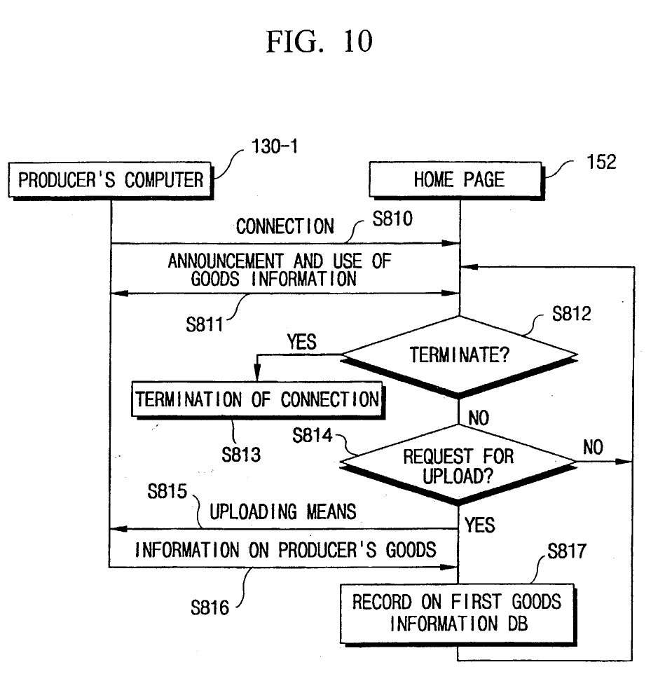

FIG. 10 is a flowchart of an exemplary upload procedure according to the present invention. Referring to FIG. 10, the home page 152 provides an arbitrary producer who has connected thereto through the Internet 110 with the service that allows an arbitrary producer to utilize information on registered goods, which is an inherent function of the home page 152 (step S810 and S811). The producer may utilize the inherent service only, and stops connecting (steps S812 and S813). Otherwise, the producer may click on an upload item shown on the screen of the home page 152 to request for upload procedure.

If the producer requests for upload procedure (step S814), the home page 152 transfers means for uploading the information on goods currently being produced or planned to produce to the producer's computer 130-1 (step S815). Then, the producer receives the goods information transferred by the uploading means (step S816) and stores the same in the first goods information DB 153-2 (step S817).

Here, the uploading means is a means which can make the producer easily transfer various kinds of information, e.g., text, image, sound, moving pictures or arrangement method of such information, and is preferably embodied through a separate window displayed on the screen of the producer's computer 130-1.

The goods information stored in the first goods information DB 153-2 is recorded on the home page 152 to be provided to various customers through the Internet.

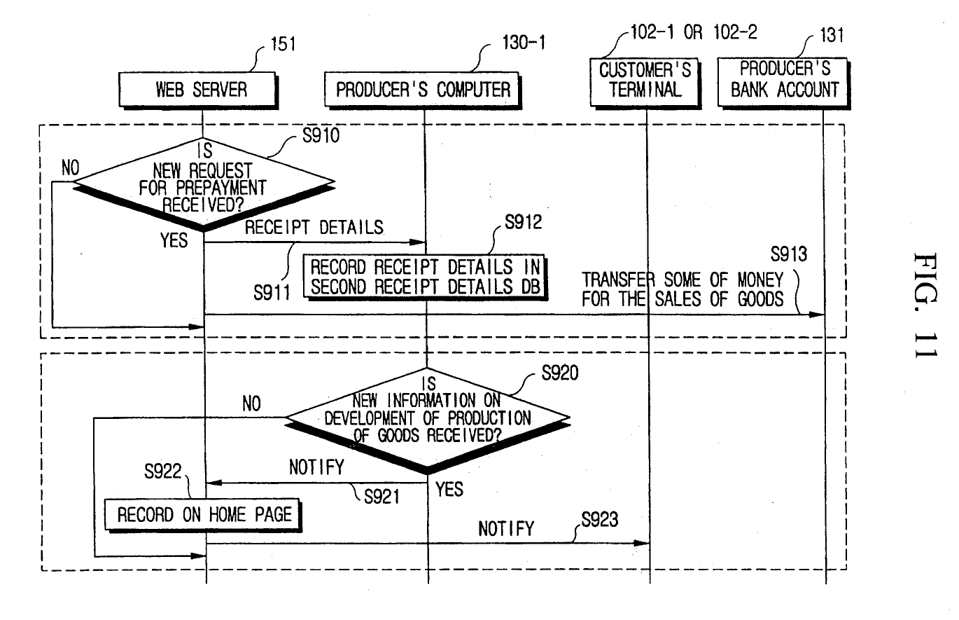

Referring to FIG. 11, the function of the system shown in FIG. 9 will be described in more detail.

If the request for prepayment is received from the customer (step S910), the web server 151 transfers the receipt details to the producer's computer 130-1 that has uploaded the corresponding goods (step S911). Then, the producer's computer 130-1 records the receipt details in the second receipt details DB 130-3 (step 8912). Also, the web server 151 transfers the money corresponding to the amount with the commission deducted from the paid money for the goods, to the producer's bank account 131 (step S913).

The production of goods is actually performed by the producer. Thus, when information on development of production of the goods is received, the producer's computer 130-1 notifies the web server 151 of the fact (step S921). Then, the web server 151 performs the occasional notice function using the information (steps S922 and S923).

In the occasional notice function, the e-mail transfer function can be performed by the producer's computer 130-1. Also, in the case where the producer is responsible for delivery of goods, the goods use information transfer function and the transportation information output function can also be performed by the producer's computer 130-1. In the case where the web sever 151 performs various functions in an integrated manner, the producer's computer 130-1 is constructed so as to transfer information necessary for performing various functions to the web server 151. It is desirable to determine whether these functions should be performed by the third operator or the producer, in consideration of service convenience and efficiency.

Distribution of profit is preferably performed by the producer or the third operator depending on each party's situation since it is quite a delicate matter from each party's viewpoint.

Although it has been described above that the home page 122 or 152 is loaded and run on the web server 121 or 151, an Internet site may be often provided using web hosting operators. Here, in the case where a web server is not capable of performing web hosting, the function of the web server 121 or 151 may be performed by the producer or the third operator after receiving necessary information from the corresponding home page 122 or 152.

Now, detailed examples of the service described above will be described.

First, prepayment for books according to the present invention will be described by way of example.

A customer connects to an Internet site and enters personal information including ID, password, address and so on to be registered as a member (subscriber). The registered subscriber accesses to a web page of his/her desired item (book) from the Internet site to review introduction of books to be published by author. The Internet site has synopses and prices of books posted by author.

Referring to the introduction, the subscriber prepays a book to be written by his/her favorite author at a predetermined price to become a pre-payer. Information on pre-payers is stored in a database until the corresponding book is completely written by the author to be published.

When the prepaid book is completed and published, autographed books are first delivered to the pre-payers and the published books are then sold to general customers. Then, profit based on sales of the books is determined in units of a predetermined time. If sales profit is generated, some of the profit is distributed to the pre-payers by cash or goods.

Next, prepayment for music records according to the present invention will be described by way of example.

A customer connects to an Internet site and enters personal information including ID, password, address and so on to be registered as a member (subscriber). The registered subscriber accesses to a web page of his/her desired item (music) from the Internet site to review introduction of records to be released by singer, theme or composer. The Internet site has synopses and prices of records posted by singer, composer or genre.

Referring to the introduction, the subscriber prepays a book to be written by his/her favorite singer at a predetermined price to become a pre-payer. Information on pre-payers is stored in a database until the corresponding record is released by the singer.

When the prepaid record is released, autographed records are first delivered to the pre-payers and the newly released records are then sold to general customers. Then, profit based on sales of the records is determined in units of a predetermined time. If sales profit is generated, some of the profit is distributed to the pre-payers by cash or goods.

Next, prepayment for drama tickets (admission tickets) according to the present invention will be described by way of example.

A customer connects to an Internet site and enters ID and password to be registered as a member (subscriber). The registered subscriber accesses to a web page of his/her desired item (drama or movie) from the Internet site to review introduction of dramas to be performed by author, theatrical company or actor/actress. The Internet site has synopses and prices of dramas posted by author, theatrical company or actor/actress.

Referring to the introduction, the subscriber prepays a drama to be performed by his/her favorite author or theatrical company at a predetermined price to become a pre-payer. Information on pre-payers is stored in a database until the corresponding drama is performed by the theatrical company or the corresponding movie is screened.

When the prepaid drama is performed, admission tickets are first delivered to the pre-payers and then sold to general customers. At this time, a souvenir autographed by popular figure(s) belonging to the theatrical company may be given to a pre-payer together with the prepaid ticket. Then, profit based on sales of the dramas is determined in units of a predetermined time. If sales profit is generated, some of the profit is distributed to the pre-payers by cash or goods.

Although examples of prepayment for books, records or dramas has been described, the present invention can be applied to prepayment for another goods such as games or living necessaries. Also, the present invention can be embodied on TV home shopping, cable broadcasting or print media as well as on the Internet.

Industrial Applicability

According to the present invention, from the viewpoint of producers, they can predict popularity of creative works to be produced by themselves and the cost required for production of the works can be secured in advance. From the viewpoint of customers, they can participate in production activities of their favorite producers and can receive autographed goods as soon as the goods are finished. Also, the customers can economically advantageously share the profit based on sales of the goods.

What is claimed is:

1. A prepayment and profit distribution system using the Internet, for providing pre-payers with goods and distributing some of profits based on sales of goods to the pre-payers, comprising:
a first goods information database (DB) for storing information on goods currently being produced or under plan for production;
a home page for providing a customer who has connected thereto through the Internet with goods information stored in the first goods information DB, and processing prepayment requests for particular goods if settlement of the price of the goods with a pertinent financial institution's server is successfully made;
a first receipt details DB for storing receipt details for the prepayment requests processed on the homepage; and
a web server for performing an “occasional notice function” of recording the information on the development of production of the goods on the home page and transferring the information on the development to e-mail addresses of the pre-payers, in connection with the first goods information DB and the first receipt details DB, a “goods use information transfer function” of transferring the information that enables the pre-payers to use the goods to the pre-payers by e-mail, if the production of the goods is finished, in connection with the first receipt details DB, a “transportation information output function” of outputting information to be indicated on the corresponding goods or packing to transport the goods to the pre-payers, in connection with the first receipt details DB, and a “profit transfer function” of transferring the profit based on sales of the goods from a designated bank account to each pre-payer's bank account, in connection with the first receipt details DB,
wherein the first goods information DB, the home page, the first receipt details DB and the web server are linked with each other on the Internet to be connected with customers on the Internet.

2. The system according to claim 1, wherein the “profit transfer function” further includes a function of transferring the amount of distribution of the profit based on sales of the goods to the customers after the production of the goods is finished to a server of each pre-payer's designated network operator and deducting the amount of distribution from charges for each pre-payer's communication services.

3. A prepayment and profit distribution system using the Internet, for providing pre-payers with goods and distributing some of profits based on sales of goods to the pre-payers, comprising:
a third operator's home page for performing a function of collecting information on goods currently being produced or planned to produce from a producer on-line on the Internet, storing the collected goods information in a first goods information DB, and providing a customer who has connected thereto through the Internet with goods information stored in the first goods information DB, and a function of recording receipt details of the pre-payers made with a pertinent financial institution's server on a first receipt details DB;
a third operator's web server for performing a function of transferring the receipt details of the pre-payers recorded on the first receipt details DB to the producer's computer having uploaded the goods information, and a function of transferring the price of the goods received from the pre-payers with the commission of the third operator deducted to the producer's designated bank account; and
the producer's computer for performing a function of transferring the goods information to a third operator's web site in connection with a second goods information DB in which the goods information currently being produced or planned to produce from the producer is stored, a function of recording the receipt details of the pre-payers transferred from the third operator's web site on a second receipt details DB, and a function of transferring information on the development of production of the goods to the third operator's web site,
wherein the third operator's web site, the producer's computer and the customer are connected with each other on the Internet.

4. The system according to claim 3, wherein the producer's computer performs an occasional notice function, a goods use information transfer function, a transportation information output function and a profit transfer function, in connection with the third operator's web site, the second goods information DB and the second receipt details DB on the Internet.
